(19) United States
(12) Patent Application Publication
(10) Pub. No.: US 2010/0088346 A1
(43) Pub. Date: Apr. 8, 2010

(54) METHOD AND SYSTEM FOR ATTACHING OBJECTS TO A DATA REPOSITORY

(75) Inventors: Mark Steven Urness, Wauwatosa, WI (US); Mohan Krishna Kommu CHS, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/247,693

(22) Filed: Oct. 8, 2008

(51) Int. Cl. G06F 17/30

(52) U.S. Cl. 707/802; 707/E17.055

(57) ABSTRACT

A method for attaching one or more objects to a data repository is presented. The method includes creating a link corresponding to each of the one or more objects. Furthermore, the method includes attaching the link corresponding to each of the one or more objects to the data repository. Systems and computer-readable medium that afford functionality of the type defined by this method is also contemplated in conjunction with the present technique.

### BACKGROUND

The invention relates generally to methods and apparatus for updating a database, and more particularly to methods and apparatus for updating a data repository without attaching the objects to the data repository.

As will be appreciated, in a clinician's office, typically an electronic medical record (EMR) system is used to maintain records related to one or more patients. An EMR is a medical report in digital format. Patient records may include one or more images obtained via use of one or more imaging systems that correspond to respective patients. It may be desirable to store the patient records, and more particularly, the one or more images corresponding to a patient, for future reference. In certain situations, these patient records may be stored in a data repository, for example. However, generally, the EMR systems are not equipped to directly accept images from an imaging system. Furthermore, if it is desirable to insert one or more images in the EMR, then the one or more image files become part of a database, and the size of the database accordingly increases. As the size of the database increases, associated problems, such as, but not limited to, database fragmentation and/or corruption of data occur, thereby leading to diminished performance of the database.

Problems associated with the growing size of the databases in medical imaging have been addressed via use of picture archiving and communication systems (PACS). As will be appreciated, PACS are computers or networks dedicated to the storage, retrieval, distribution and presentation of images. The medical images are stored in an independent format. The most common format for image storage is the DICOM (Digital Imaging and Communications in Medicine) format. Most PACS handle images from various medical imaging systems, including ultrasound, magnetic resonance (MR), positron emission tomography (PET), computed tomography (CT), endoscopy, mammograms, and the like. However, use of a PACS system in addition to the EMR system results in increased cost.

In addition, there also exist several techniques configured to aid in attaching one or more objects, such as images, to the data repository. Using currently available techniques, a user may be provided direct access to a target database. However, use of these techniques calls for the user to actually log into the target database with a username and password. It may be noted that this method works well if a single entity controls both the clients and the database. Unfortunately, when there is a client of one vendor and a database of another vendor, problems arise, as different vendors may not share database access.

Furthermore, use of other currently available techniques entails the database parsing an object for tags. As will be appreciated, files that follow the DICOM standard typically have tags imbedded into the image to allow database records and a file location pointer to be created. However, non-DICOM image files, such as JPEG files, generally do not include tags to parse. Hence, these techniques fail to facilitate generation of a reference to the database for all types of image file formats.

Additionally, certain other currently available techniques call for attaching an object to a database by simply importing the entire object into the database. In other words, using these methods, the entire file is inserted into the database. Unfortunately, the database will grow by the size of the attached file. These techniques are particularly troublesome when attaching a large number of objects to the database.

Moreover, a Health Level Seven (HL7) interface may be implemented on the client and the server to exchange update messages, where HL7 and its members may be configured to provide a framework (and related standards) for the exchange, integration, sharing and retrieval of electronic health information. However, use of the HL7 interface is very expensive and involves extensive configuration.

It may therefore be desirable to develop a robust technique and system configured to aid in attaching one or more objects to a data repository that advantageously facilitates enhanced workflow, while simultaneously maintaining the size of the data repository to a minimum. In particular, there is a need for a system that is configured to facilitate attaching one or more objects to the data repository, thereby enhancing ease of clinical workflow of the diagnostic imaging system.

### BRIEF DESCRIPTION

In accordance with aspects of the present technique, a method for attaching one or more objects to a data repository is presented. The method includes creating a link corresponding to each of the one or more objects. Furthermore, the method includes attaching the link corresponding to each of the one or more objects to the data repository. Computer-readable medium that afford functionality of the type defined by this method is also contemplated in conjunction with the present technique.

In accordance with yet another aspect of the present technique, a method for attaching one or more objects to a data repository is presented. The method includes obtaining one or more objects. Further, the method includes creating a link corresponding to each of the one or more objects. The method also includes storing the one or more objects in a first data repository. Moreover, the method includes attaching the links corresponding to each of the one or more objects to a second data repository, where the second data repository is operationally coupled to the first data repository. The method also includes accessing one or more objects from the first data repository.

In accordance with further aspects of the present technique, a file saving system is presented. The file saving system includes a file saving platform configured to create a link corresponding to each of the one or more objects, and attach the link corresponding to each of the one or more objects to a data repository.

In accordance with further aspects of the present technique, a system is presented. The system includes a data source, where the data source includes an acquisition subsystem configured to acquire one or more objects, where the one or more objects comprises one or more images, log files, video clippings, reports, measurement values stored in text files, or other data files that include information, and a processing subsystem in operative association with the acquisition subsystem and configured to process the one or more objects. Furthermore, the system includes a data storage system, where the data storage system includes a data acquisition subsystem configured to receive the one or more objects, a file saving platform configured to create a link corresponding to each of the one or more objects, and attach the link corresponding to each of the one or more objects to a data repository, and a storage subsystem configured to store the one or more objects, the links corresponding to each of the one or more objects, or a combination thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary diagnostic system, in accordance with aspects of the present technique;

FIG. 2 is a block diagram of an exemplary imaging system for use in the exemplary diagnostic system of FIG. 1;

FIG. 3 is a block diagram of an exemplary file saving platform, in accordance with aspects of the present technique;

FIGS. 4A-4B are flow charts illustrating an exemplary process of attaching one or more objects to a data repository, in accordance with aspects of the present technique;

FIGS. 5A-5B are flow charts illustrating an exemplary process of accessing one or more objects attached to a data repository, in accordance with aspects of the present technique; and

FIG. 6 is a diagrammatic illustration of the method of attaching one or more objects to a data repository, in accordance with aspects of the present technique.

### DETAILED DESCRIPTION

As will be described in detail hereinafter, a method for attaching one or more objects to a data repository and a system for attaching one or more objects to a data repository configured to optimize utilization of data repositories and simplify clinical workflow in a diagnostic imaging system, are presented. Employing the method and system described hereinafter, substantially superior usage of precious data repository space may be obtained, thereby simplifying the clinical workflow of the detection of disease.

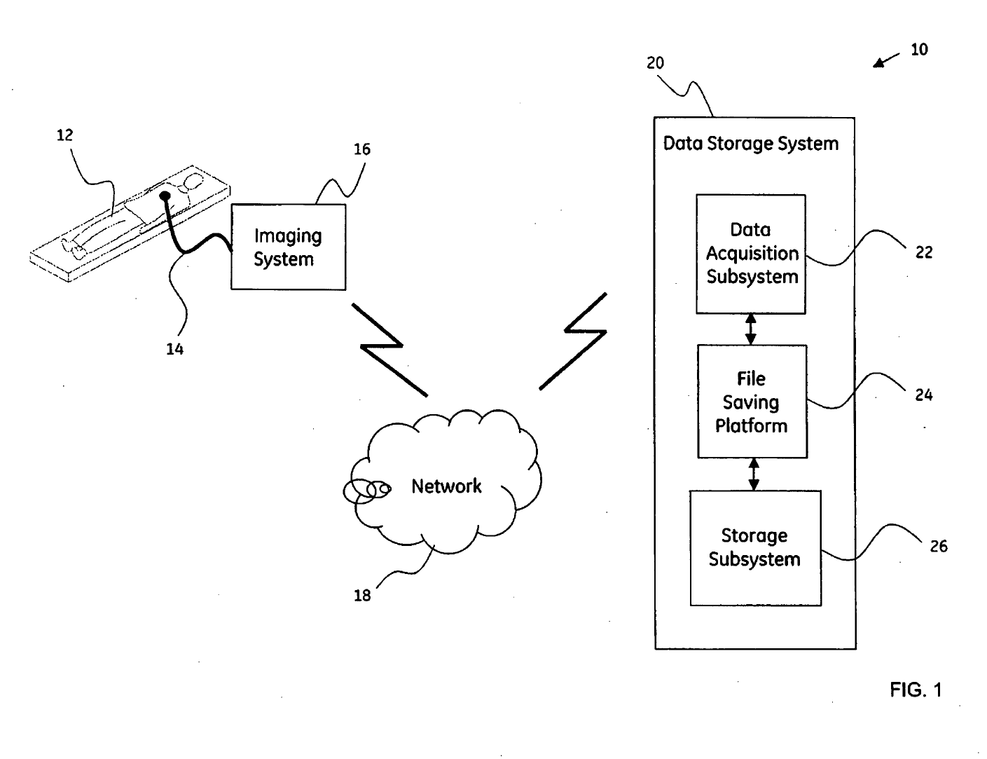

FIG. 1 is a block diagram of an exemplary system 10 for use in diagnostic imaging, in accordance with aspects of the present technique. As will be appreciated by one skilled in the art, the figures are for illustrative purposes and are not drawn to scale. The system 10 may be configured to acquire image data from a patient 12 via an image acquisition device 14. In one embodiment, the image acquisition device 14 may include a probe, where the probe may include an invasive probe, or a non-invasive or external probe, such as an external ultrasound probe, that is configured to aid in the acquisition of image data. Also, in certain other embodiments, image data may be acquired via one or more sensors (not shown) that may be disposed on the patient 12. By way of example, the sensors may include physiological sensors (not shown) such as electrocardiogram (ECG) sensors and/or positional sensors such as electromagnetic field sensors or inertial sensors. These sensors may be operationally coupled to a data acquisition device, such as an imaging system, via leads (not shown), for example.

The system 10 may also include a medical imaging system 16 that is in operative association with the image acquisition device 14. It should be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ an imaging system in conjunction with other imaging modalities, position-tracking systems or other sensor systems. Furthermore, it should be noted that the medical imaging system 16 may include imaging systems, such as, but not limited to, an X-ray imaging system, a magnetic resonance (MR) imaging system, an ultrasound imaging system, a positron emission tomography (PET) imaging system, a computed tomography (CT) imaging system, or the like.

It may be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ ultrasound imaging in conjunction with other imaging modalities, position-tracking systems or other sensor systems. Furthermore, it should be noted that although the exemplary embodiments illustrated hereinafter are described in the context of a medical imaging system, such as, but not limited to, an ultrasound imaging system, an optical imaging system, a CT imaging system, a MR imaging system, an X-ray imaging system, or a PET imaging system, other imaging systems, such as, but not limited to, a pipeline inspection system, a liquid reactor inspection system, or other imaging systems are also contemplated in accordance with aspects of the present technique. It may also be noted that the present technique may also find application in a wide variety of electronic systems. For example, use of the present technique in applications, such as, but not limited to, generators and wind turbines are also contemplated.

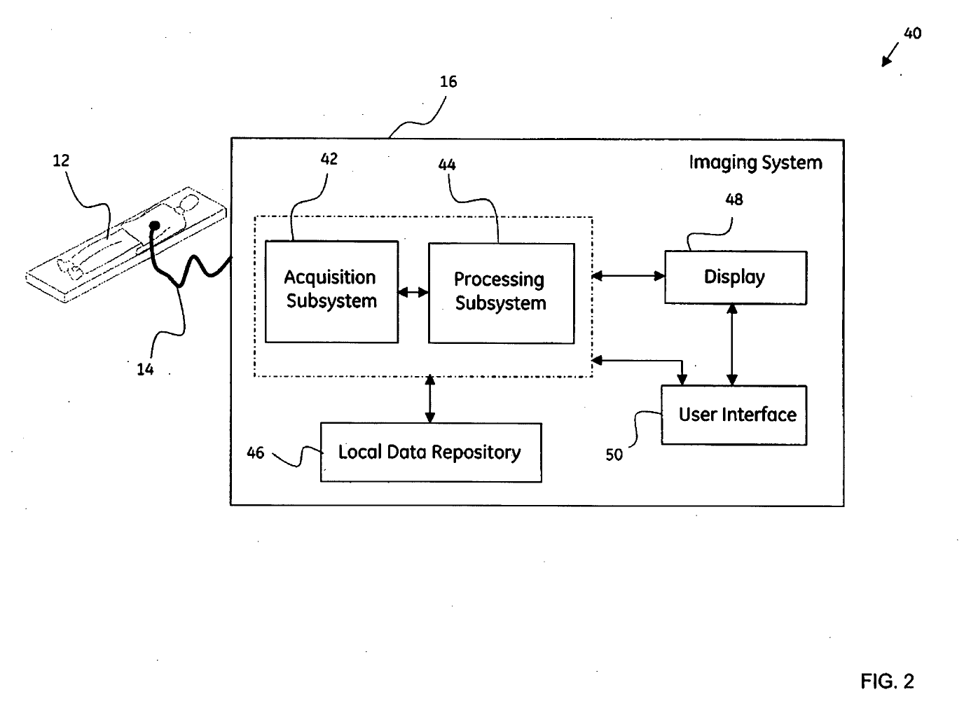

Referring now to FIG. 2, one embodiment 40 of the medical imaging system 16 of FIG. 1 is illustrated. In a presently contemplated configuration, the medical imaging system 16 may include an acquisition subsystem 42 and a processing subsystem 44. Further, the acquisition subsystem 42 of the medical imaging system 16 may be configured to acquire image data representative of one or more anatomical regions in the patient 12 (see FIG. 1) via the image acquisition device 14 (see FIG. 1). The image data acquired from the patient 12 may then be processed by the processing subsystem 44.

Additionally, the image data acquired and/or processed by the medical imaging system 16 may be employed to aid a clinician in identifying disease states, assessing need for treatment, determining suitable treatment options, and/or monitoring the effect of treatment on the disease states. In certain embodiments, the processing subsystem 44 may be further coupled to a storage system, such as a local data repository 46, where the data repository 46 may be configured to receive and store image data.

Further, as illustrated in FIG. 2, the medical imaging system 16 may also include a display 48 and a user interface 50. However, in certain embodiments, such as in a touch screen, the display 48 and the user interface 50 may overlap. Also, in some embodiments, the display 48 and the user interface 50 may include a common area. In accordance with aspects of the present technique, the display 48 of the medical imaging system 16 may be configured to display an image generated by the medical imaging system 16 based on the image data acquired via the image acquisition device 14.

In addition, the user interface 50 of the medical imaging system 16 may include a human interface device (not shown) configured to aid the clinician in manipulating image data displayed on the display 48. The human interface device may include a mouse-type device, a trackball, a joystick, a stylus, or a touch screen configured to aid the clinician in the identification of the one or more regions of interest requiring treatment, for instance. However, as will be appreciated, other human interface devices, such as, but not limited to, a touch screen, may also be employed. Furthermore, the user interface 50 may also be configured to aid the clinician in navigating through the images acquired by the medical imaging system 16. Additionally, the user interface 50 may also be configured to aid in manipulating and/or organizing the images displayed on the display 48.

As previously noted with reference to FIG. 2, the images may be stored in the local data repository 46. With returning reference to FIG. 1, it may be also be desirable to store the image data acquired via the medical imaging system 16 in a database, for example. Accordingly, the image data acquired and processed by the medical imaging system 16 may be communicated to a first storage 20. In a presently contemplated configuration, the first storage 20 may include a data storage system. Also, in one embodiment, the data storage system 20 may be at a location that is physically remote from the location of the medical imaging system 16. However, as will be appreciated, in certain embodiments, the data storage system 20 may be disposed in substantially close proximity to the medical imaging system 16.

Moreover, in one embodiment, the image data acquired and/or processed by the medical imaging system 16 may be communicated to the data storage system 20 via a network 18. It may be noted that other means of communication, such as, but not limited to, the Internet, the intranet, or wireless communication may also be employed to transmit the image files from the medical imaging system 16 to the data storage system 20. Furthermore, in one embodiment, the image data may be transmitted to the data storage system 20 in real-time. Alternatively, the image data may be temporarily stored in a temporary storage, such as the local data repository 46 (see FIG. 2) and communicated to the data storage system 20 at a later time.

Further, in one embodiment, the data storage system 20 may include a data acquisition subsystem 22, where the data acquisition subsystem 22 may be configured to receive the image data transmitted from the medical imaging system 16 via the network 18. The image data received by the data acquisition subsystem 22 may be stored in a data repository 26. In the example illustrated in FIG. 1, the data repository 26 may include a storage subsystem. Also, in one embodiment, the storage subsystem 26 may include an archival site, a database, or an optical data storage article. It may be noted that the optical data storage article may be an optical storage medium, such as a compact disc (CD), a digital versatile disc (DVD), multi-layer structures, such as DVD-5 or DVD-9, multi-sided structures, such as DVD-10 or DVD-18, a high definition digital versatile disc (HD-DVD), a Blu-ray disc, a near field optical storage disc, a holographic storage medium, or another like volumetric optical storage medium, such as, for example, two-photon or multi-photon absorption storage format.

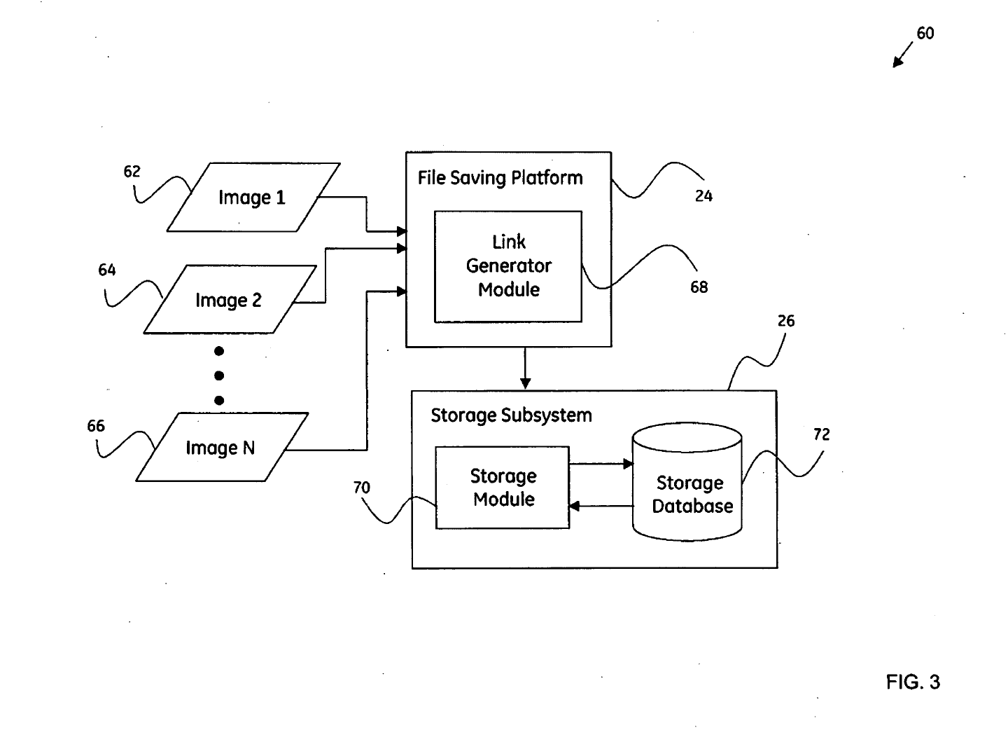

In accordance with exemplary aspects of the present technique, the diagnostic system 10 may also include a file saving platform 24, where the file saving platform 24 may be configured to aid in saving of the image data in the storage subsystem 26. More particularly, the file saving platform 24 may be configured to generate a reference pointer to each of the one or more images received by the data acquisition system 22. Additionally, the file saving platform 24 may also be configured to save the one or more images in a first portion of the storage subsystem 26, while the reference pointers corresponding to the one or more images may be stored in a second portion of the storage subsystem 26. The working of the file saving platform 24 will be explained in greater detail with reference to FIGS. 3-6.

As will be appreciated, use of currently available techniques entails a client attaching itself directly to the database to upload or create an object link. However, this requires the client to actually login to the target database with a username and password. Use of another currently available technique calls for a database parsing of a file object for tags. In addition, other currently available techniques call for attaching an object to a database by importing the entire object into the database, thereby disadvantageously resulting in the database growing by the size of the attached file. Furthermore, implementing HL7 interfaces on the client and the server to exchange update messages is very expensive and involves extensive configuration.

The shortcomings of the currently available techniques may be circumvented by use of the present technique. More particularly, in accordance with exemplary aspects of the present technique, use of reference pointers advantageously allows attachment of non-tagged objects into a database without having the actual object inserted into the database, client access to the database. In other words, reference pointers corresponding to the images may be stored in the data repository instead of the actual image file. This exemplary process of attaching one or more objects to the data repository by storing reference pointers corresponding to the one or more objects may be better understood with reference to FIG. 3.

Turning now to FIG. 3, one embodiment 60 of the file saving platform 24 (see FIG. 1) is illustrated. As previously noted, one or more images representative of the patient 12 (see FIG. 1), generated by the imaging system 16 (see FIG. 1) may be communicated to the data acquisition system 22 in the data storage system 20 via the network 18 for storage. In the example illustrated in FIG. 3, reference numeral 62 may be representative of a first image, while a second image may generally be represented by reference numeral 64. In a similar fashion, reference numeral 66 may be indicative of an Nth image. These images 62, 64, 66 may then be communicated to the file saving platform 24 for further processing. As previously noted, the file saving platform 24 may be configured to aid in dramatically reducing the storage overhead on the data storage system 20 by saving a link to the image, instead of the actual image.

In accordance with exemplary aspects of the present technique, the system 10 (see FIG. 1) may be configured to generate a link corresponding to each of the images to be saved. Accordingly, the system 10, and more particularly, the file saving platform 24, may be configured to include a link generator module 68. The link generator module 68 may be configured to generate a link corresponding to each of the one or more images 62, 64, 66. In one embodiment, this link may include a hypertext markup language (HTML) link. Alternatively, the links may include other types of pointers and/or links. It may be noted that the terms links, pointers and reference pointers may be used interchangeably.

Once the links corresponding to the one or more images 62, 64, 66 are generated, the file saving platform 24 may be configured to aid in saving the one or more images 62, 64, 66. In addition, the file saving platform 24 may also be configured to aid in saving the links to the one or more images. More particularly, the file saving platform 24 may be configured to aid in facilitating saving of the one or more generated links in a data repository, where the links correspond to each of the one or more images 62, 64, 66 to be saved. In other words, a first link corresponding to the first image 62 to be saved may be generated by the link generator module 68. Similarly, the link generator module may also be configured to generate a second link corresponding to the second image 64 to be saved. Moreover, an Nth link corresponding to the Nth image 66 to be saved may be generated by the link generator module 68.

With continuing reference to FIG. 1, in one embodiment, the storage subsystem 26 (see FIG. 1) may include a storage module 70 and a storage database 72. The file saving platform 24 may be configured to store the one or more images 62, 64, 66 in the storage module 70 and store the reference pointers corresponding to the one or more images 62, 64, 66 in the storage database 72. Alternatively, in certain other embodiments, the file saving platform 24 may be configured to store the reference pointers corresponding to the one or more images 62, 64, 66 in the storage module 70 and store the one or more images 62, 64, 66 in the storage database 72. Subsequently, a listing of these reference pointers may be presented to the clinician. By way of example, the listing of the reference pointers corresponding to the images 62, 64, 66 may be displayed on the display 48 (see FIG. 2).

Traditionally, use of certain techniques entails storing of the images in the database, thereby resulting in the size of the database growing with each image added. By implementing the method of attaching one or objects, such as images, to the data repository as described hereinabove, the reference pointers associated with each of the one or more images may be saved in the storage database 72, thereby circumventing the shortcomings of presently available techniques.

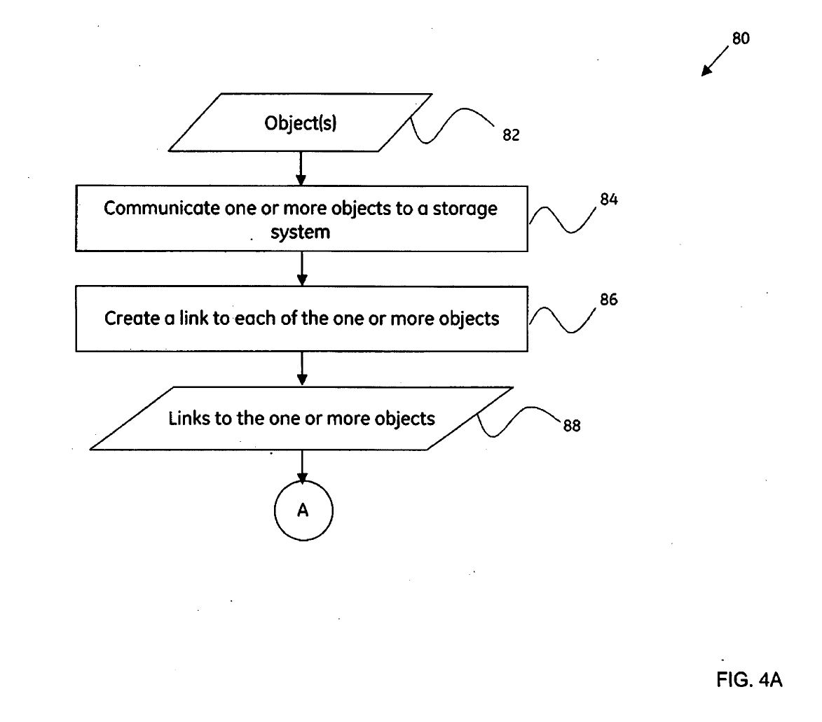

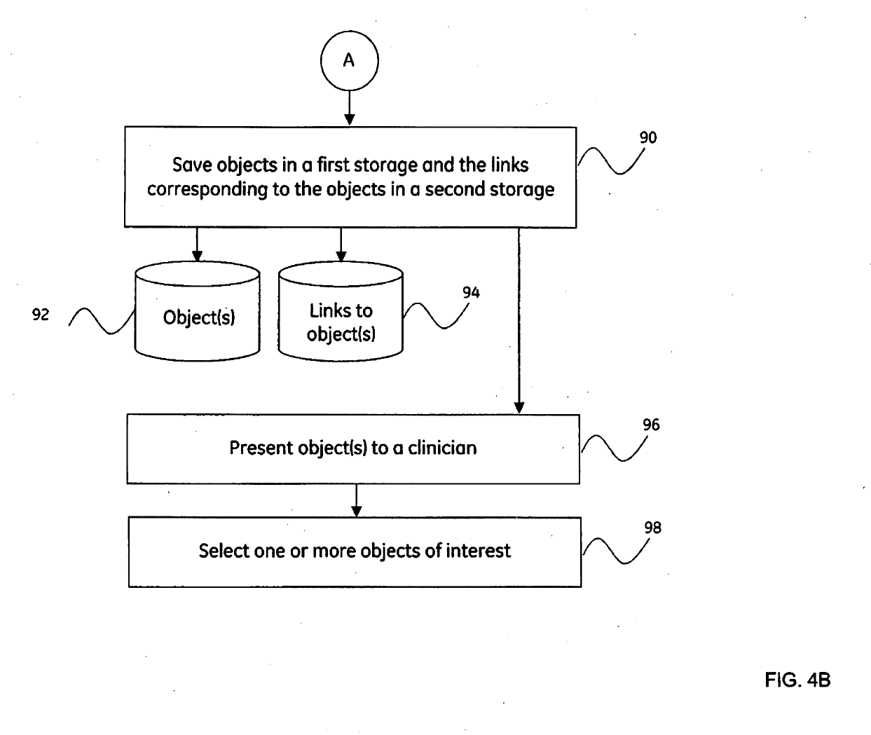

It may be desirable for a user, such as a clinician, to access one or more images. These images may generally be referred to as images of interest. In accordance with exemplary aspects of the present technique, once it is desirable for the clinician to access one or more images of interest, the clinician may select the one or more reference pointers from the listing of reference pointers displayed on the display 48, for instance. In other words, the clinician is selecting one or more reference pointers corresponding to the images of interest. More particularly, once the clinician selects the reference pointers corresponding to the images of interest, then the selected reference pointers may in turn be configured to access the corresponding images of interest from the storage module 70. The working of the file saving platform 24 and the link generator module 68 will be described in greater detail with reference to FIGS. 4-6.

The working of the system 10 (see FIG. 1), and more particularly the working of the file saving platform 24 (see FIG. 1) having the link generator module 68 (see FIG. 3) may be better understood with reference to the exemplary logic depicted in FIGS. 4-6. Referring now to FIG. 4, a flow chart of exemplary logic 80 for attaching objects to a data repository is illustrated. In accordance with exemplary aspects of the present technique, a method for attaching one or more objects to a data repository is presented. In the example presented in FIG. 4, a method for attaching objects, such as images, to a data repository, such as a database, is presented. Although the present example describes the method of attaching objects to a database with reference to one or more images, it may be noted that the objects may include other data, such as, but not limited to, log files, video clips, completed reports, measurement values stored in text files, or other data files that include information. It may be noted that the information in the other data files may include non-text data, in certain embodiments.

The method starts at step 84, where one or more objects 82 may be communicated to a data storage system, such as the data storage system 20 (see FIG. 1), via the network 18 (see FIG. 1), for instance. The one or more objects 82 may include one or more images acquired via an imaging system, such as the imaging system 16 (see FIG. 1). As will be appreciated, once the one or more images are communicated to the data storage system 20, it may be desirable to store the one or more images 82 in the data storage system 20.

In accordance with exemplary aspects of the present technique, a reference link or pointer to the one or more images 82 may be stored in the database, as opposed to the one or more image files, thereby maintaining the size of the database at an optimum level. Accordingly, a link may be created corresponding to each of the one or more images 82, as indicated by step 86. The link generator module 68 (see FIG. 3) in the file saving platform 24 may be employed to aid in the generation of the links corresponding to the one or more images 82. The links so generated may generally be represented by reference numeral 88.

Subsequent to the generation of the links 88, it may be desirable to store the one or more images 82 and the corresponding links 88. Accordingly, at step 90, the one or more images 82 may be stored in a first storage 92. In one embodiment, the first storage 92 may include a data repository, such as a database. Alternatively, the first storage 92 may include a local data repository, such as the storage module 70 (see FIG. 3). In addition, the links 88 corresponding to the images 82 may be stored in a second storage 94. In certain embodiments, the second storage 94 may include a data repository, such as the storage database 74 (see FIG. 3).

Subsequently, at step 96, the one or more images 82 may be presented to the clinician. Traditionally, a listing of the one or more images 82 may be presented to the clinician. However, in accordance with exemplary aspects of the present technique, a listing of the links 88 corresponding to the one or more images 82 is presented to the clinician. In one embodiment, user-viewable representations of the links 88 may be generated and displayed to the clinician. By way of example, the listing of links 88 may be displayed on the display 48 (see FIG. 2).

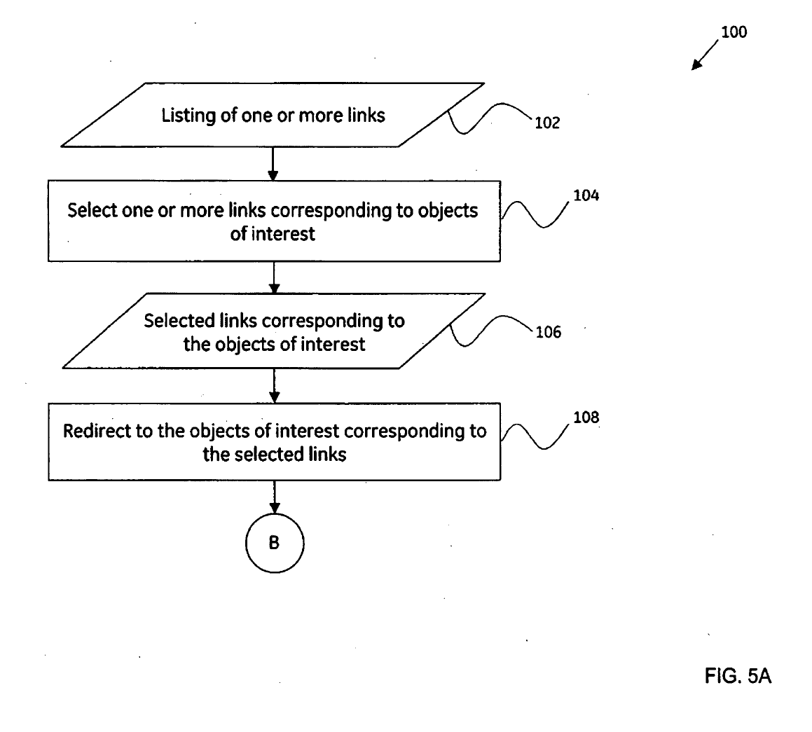

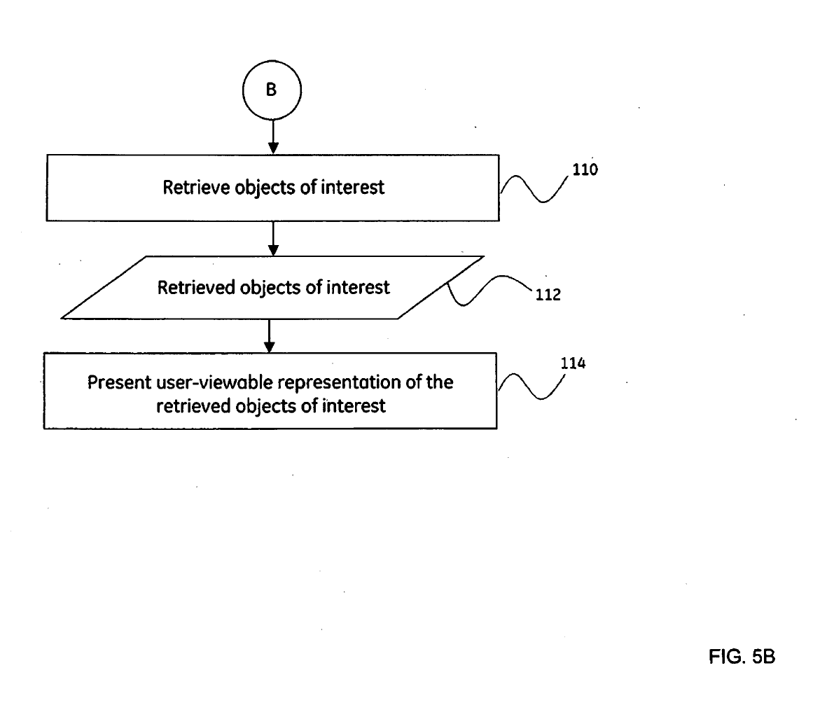

Furthermore, at step 98, once the listing of links corresponding to the one or more images is presented to the clinician, the clinician may then select one or more links, where the one or more selected links may correspond to one to more images of interest. It may be noted that the term images of interest may be used to refer to one or more images that the clinician desires to view. In accordance with aspects of the present technique, when the clinician selects a link from the listing of one or more links 88, the system 10 (see FIG. 1) may be configured to redirect the link to the corresponding image 82, and will be described in greater deal with reference to FIG. 5.

As noted hereinabove, traditionally, the listing of images 82 stored in the first storage 92, for example, may be presented to the clinician. However, in accordance with exemplary aspects of the present technique, the links 88 corresponding to so stored in the storage database 74 may be made available to the clinician, instead of the images 82. It may be desirable for the clinician to access these images 82 for further study. Accordingly, a method of accessing one or more images, such as the images 82, is presented. In other words, step 98 of FIG. 4 is illustrated in greater detail is illustrated in FIG. 5. Referring now to FIG. 5, a flow chart of exemplary logic 100 for accessing objects in a data repository is depicted. In accordance with exemplary aspects of the present technique, a method for accessing one or more objects in a data repository is presented. In the example presented in FIG. 5, a method for accessing objects, such as images, in a data repository, such as a database, is presented. Here again, although the present example describes the method of attaching objects to a database with reference to one or more images, it may be noted that the objects may include other data, such as, but not limited, to log files, video clips, completed reports, measurement values stored in text files, or other data files that include information.

The selection of one or more images by the may be better understood with reference to FIG. 5. Referring now to FIGS. 5A-5B, a flow chart 100 illustrating an exemplary method of accessing one or more images is depicted. More particularly, a method of accessing one or more objects from a data repository is presented. As described hereinabove, in accordance with exemplary aspects of the present technique, links or reference pointers corresponding to the images may be stored in the data repository instead of the actual image files, thereby resulting in substantial space saving. Further, a listing 102 of the links 88 (see FIG. 4) may be presented to the clinician.

The method starts at step 104, where the clinician may select one or more objects from a listing of one or more links or reference pointers, where the links correspond to one or more images, such as the images 82 (see FIG. 4). More particularly, in accordance with exemplary aspects of the present technique, the listing 102 of one or more links 88 essentially may include a listing 102 of one or more links 88 corresponding to each of the one or more images 82. It may be desirable for the clinician to select one or more links corresponding to the one or more images of interest to be viewed by the clinician. Consequent to the selection of one or more links by the clinician, one or more selected links 106 may be obtained, where the selected links 106 may correspond to the one or more images of interest.

Once the clinician selects one or more links 106, the system 10 may be configured to redirect the system 10 to the one or more images corresponding to the selected links 106, as indicated by step 108. In other words, in the example illustrated in FIG. 3, the one or more images 62, 64, 66 may be stored in the storage module 70 (see FIG. 3), while the links corresponding to the one or more images 62, 64, 66 may be stored in the storage database 72 (see FIG. 3), as previously noted. Accordingly, when the clinician selects one or more links 106 corresponding to the images of interest, the system 10 may be configured to select the corresponding images of interest from the storage module 70, for example. In other words, the selected links 106 may be configured to in turn select the one or more images of interest from the storage module 70, where the one or more images of interest correspond to the selected links 106, as indicated by step 110. More particularly, at step 110, the one or more images of interest that correspond to the selected links 106 may be retrieved. In the present example, these images of interest may be retrieved from the storage module 70. The retrieved images of interest may generally be represented by reference numeral 112. Once the images 112 are retrieved, the retrieved images 112 may be presented to the clinician, as indicated by step 114. In other words, user-viewable representations of the retrieved images 112 may be generated and presented to the clinician.

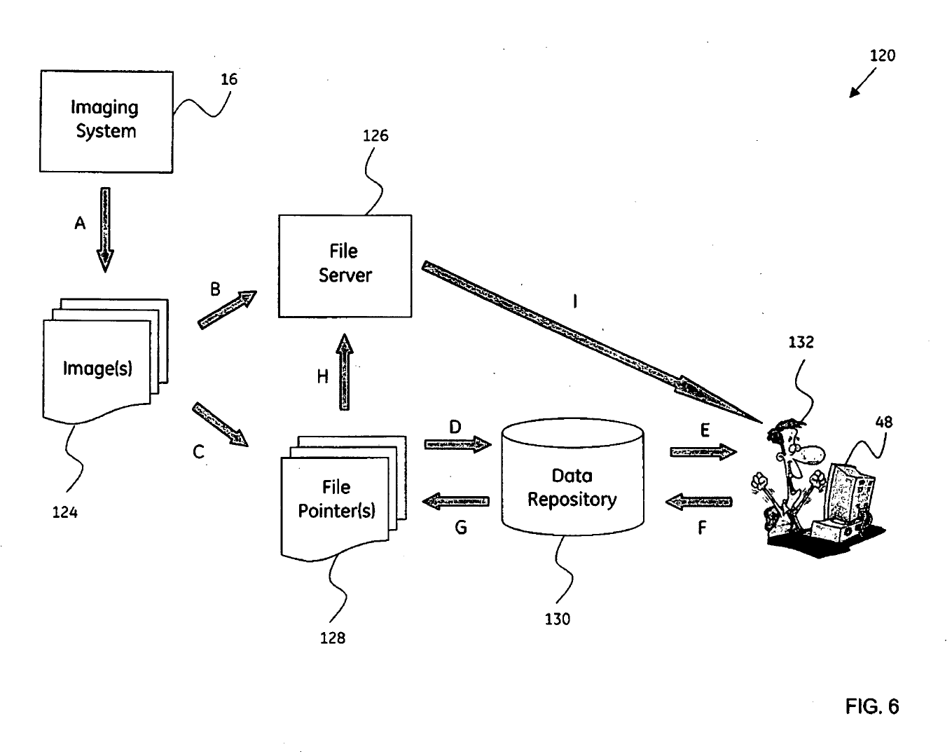

The methods presented in FIGS. 4-5 may be better understood with reference to FIG. 6. Referring now FIG. 6, a diagrammatic illustration 120 of steps of FIGS. 4-5 is depicted. More particularly, one example of a workflow for attaching one or more objects to a data repository is depicted in FIG. 6. As previously described, the imaging system 16 (see FIG. 1) may be configured to aid in the acquisition of image data from one or more patients, such as the patient 12 (see FIG. 1). Subsequently, as indicated by step “A”, the imaging system 16 may be configured to generate one or more images representative of the one or more patients using the acquired image data. Reference numeral 124 may generally be representative of these images. By way of example, these images 124 may include the first image 62, the second image 64 and the Nth image 66 of FIG. 3.

As will be appreciated, it may be desirable to store these images 124, as indicated by step “B”. In the present example, the images 124 are shown as being stored in a data repository, such as a file server 126. As previously noted, the file server 126 may include the storage module 70 of FIG. 3. In accordance with exemplary aspects of the present technique, in addition to storing these images 124 in the file server 126, reference pointers to each of these images 124 may be generated, as depicted by step “C”. The reference pointers so generated may generally be represented by reference numeral 128. As previously noted, the file saving platform 24 (see FIG. 1), and more particularly the link generator module 68 (see FIG. 3) may be configured to aid in the generation of the reference pointers 128 corresponding to each of these images 124. Subsequently, at step “D”, these reference pointers 128 may be stored in a data repository. In the example illustrated in FIG. 6, the reference pointers 128 are shown as being saved in a data repository 130. As previously noted, the data repository 130 may include the storage database 72 of FIG. 3. It may be noted that in certain embodiments, the reference pointers 128 may also be stored in a portion of the file server 126. By saving the reference pointers 128 corresponding to the images 124, the size of the data repository 130 may be allowed to grow in a controlled manner. Moreover, a listing of the one or more reference pointers 128 may be displayed on the display 48 (see FIG. 2), as indicated by step “E”.

Furthermore, a clinician 132 may desire to view one or more images associated with a patient, for example. Accordingly, the clinician 132 may select one or more links from the listing of links displayed on the display 48, where the selected links correspond to one or more images that the clinician 132 desires to view. In other words, the clinician 132 may select one or more links from a listing of links associated with a patient displayed on the display 48 (see FIG. 2), for example. Once the clinician 132 selects one or more links from the listing of links, in accordance with exemplary aspects of the present technique, links corresponding to the selected links may be selected. In other words, at step “F”, once the clinician 132 selects the one or more links, the system 10 (see FIG. 1) may be configured to select the corresponding links from the data repository 130. Consequent to step “F”, links 128 corresponding to the selected one or more links may be obtained, as indicated by step “G”. These links may then be employed to retrieve one or more images corresponding to the selected links. More particularly, the one or more images corresponding to the selected links may be retrieved from the file server 126, as depicted by step “H”. Subsequently, the retrieved images may be presented to the clinician 132, as indicated by step “I”.

As noted hereinabove, directly attaching image files to the data repository unfortunately takes up unnecessary space and creates additional overhead for each image file added. By implementing the system and method for attaching one or more objects to a data repository as described hereinabove, instead of taking up the space from the original object, the present technique may be configured to use a link acting as a virtual reference in the data repository. A clinician, such as the clinician 132, may then access this virtual link and be redirected to a webpage that contains the original file using a locally installed browser program. Consequently, the space savings to the data repository are substantially extensive. More particularly, a file corresponding to the reference pointers may be configured to have a size of about 1 kilobyte. It may also be noted that the size of the file corresponding to the reference pointer may be configured to have a size of about 1 kilobyte irrespective of the size of the corresponding image file. Also, as the object, such as the image, resides on the client machine, no specific viewers have to be added to the database server to aid the clinician in viewing the object.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, including but not limited to C++ or Java. Such code, as will be appreciated by those of ordinary skill in the art, may be stored or adapted for storage on one or more tangible, machine readable media, such as on memory chips, local or remote hard disks, optical disks (that is, CD's or DVD's), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The above-description of the embodiments of the method of attaching one or more objects to a data repository and the system for attaching one or more objects to a data repository have the technical effect of enhancing clinical workflow by attaching reference pointers having a substantially fixed size to the data repository instead of the actual image files, thereby advantageously resulting in space savings in the data repository and preventing the database growing to unmanageable sizes. Additionally, the system and method described hereinabove allow better integration with other data repositories.

The method of attaching one or more objects to a data repository and the system for attaching one or more objects to a data repository described hereinabove dramatically simplify procedural workflow for the detection of disease states in an anatomical region in the patient and enhance the speed of procedural time taken to detect and/or diagnose the presence of disease states in the anatomical region of the patient. In other words, the method and system for attaching one or more objects to data repository may be configured to attach reference pointers corresponding to one or more objects to the data repository, where the reference pointers include files of a substantially fixed size thereby advantageously resulting in space savings in the data repository. In other words, database attachments will not grow a database into unmanageable sizes. Moreover, the system and method for attaching described hereinabove may be configured to accomplish attaching objects to the data repository without the need of accessing the database, parsing file tags, or directly importing the object into the data repository. Furthermore, using the above system and method clients do not have to use DICOM or other tagged files, thereby providing the clients with the freedom to use standard images (JPG or AVI) along with PDF files and still attach them into database systems. Also, use of the above system and method allows for easier integration with other database systems.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for attaching one or more objects to a data repository, the method comprising:
creating a link corresponding to each of the one or more objects; and
attaching the link corresponding to each of the one or more objects to the data repository.

2. The method of claim 1, wherein the one or more objects comprises one or more images, log files, video clippings, reports, measurement values stored in text files, or other data files that include information.

3. The method of claim 1, further comprising obtaining image data from a data source, wherein the image data is representative of an anatomical region, wherein the data source comprises a data stream or archived data, and wherein the archived data is obtained from a first storage.

4. The method of claim 1, further comprising communicating the one or more objects to a first data repository.

5. The method of claim 4, further comprising storing the one or more objects in the first data repository.

6. The method of claim 5, further comprising storing the one or more links in a second data repository, wherein the second data repository is operationally coupled to the first data repository.

7. The method of claim 6, further comprising generating user-viewable representations of the one or more links.

8. The method of claim 7, further comprising presenting a listing of the user-viewable representations of the one or more links to a user.

9. The method of claim 8, further comprising selecting one or links from the listing of user-viewable representations of the one or more links.

10. The method of claim 9, wherein selecting one or more links to be displayed comprises selecting links corresponding to one or more objects to be viewed by the user.

11. The method of claim 10, further comprising retrieving one or more objects corresponding to the selected links from the first data repository.

12. The method of claim 11, further comprising presenting user-viewable representations of the retrieved objects to the user.

13. A method for attaching one or more objects to a data repository, the method comprising:
obtaining one or more objects;
creating a link corresponding to each of the one or more objects;
storing the one or more objects in a first data repository;
attaching the link corresponding to each of the one or more objects to a second data repository, wherein the second data repository is operationally coupled to the first data repository; and
accessing one or more objects from the first data repository.

14. The method of claim 13, further comprising generating user-viewable representations of the one or more links.

15. The method of claim 14, further comprising presenting a listing of the user-viewable representations of the one or more links to a user.

16. The method of claim 15, wherein accessing one or more objects from the first data repository comprises selecting one or more links from the listing of user-viewable representations of the one or more links.

17. The method of claim 16, wherein selecting one or more links to be displayed comprises selecting links corresponding to one or more objects of interest.

18. The method of claim 17, further comprising retrieving one or objects corresponding to the selected links from the first data repository.

19. The method of claim 18, further comprising presenting user-viewable representations of the retrieved objects to the user.

20. A computer readable medium comprising one or more tangible media, wherein the one or more tangible media comprise:
code adapted to create a link corresponding to each of one or more objects; and
code adapted to attach the link to each of the one or more objects to the data repository.

21. A file saving system, comprising:
a file saving platform configured to:
create a link corresponding to each of one or more objects; and
attach the link corresponding to each of the one or more objects to a data repository.

22. A system, comprising:
a data source, wherein the data source comprises:
an acquisition subsystem configured to acquire one or more objects, wherein the one or more objects comprises one or more images, log files, video clippings, reports, measurement values stored in text files, or other data files that include information;
a processing subsystem in operative association with the acquisition subsystem and configured to process the one or more objects;
a data storage system, wherein the data storage system comprises:
a data acquisition subsystem configured to receive the one or more objects;
a file saving platform configured to:
create a link corresponding to each of the one or more objects;
attach the link corresponding to each of the one or more objects to a data repository; and
a storage subsystem configured to store the one or more objects, the links corresponding to each of the one or more objects, or a combination thereof.

23. The system of claim 22, further configured to store the one or more objects in a first data repository.

24. The system of claim 23, further configured to store the one or more links in a second data repository, wherein the second data repository is operationally coupled to the first data repository.

25. The system of claim 24, further configured to present a listing of user-viewable representations of the one or more links to a user.
